(19) United States
(12) Patent Application Publication
(10) Pub. No.: US 2020/0406712 A1
(43) Pub. Date: Dec. 31, 2020

(54) HEATER APPARATUS

(71) Applicant: DENSO CORPORATION, Kariya-city (JP)

(72) Inventors: Yusuke TANAKA, Kariya-city (JP); Kimitake ISHIKAWA, Kariya-city (JP); Hideki SEKI, Kariya-city (JP); Hirokazu YAMADAKI, Kariya-city (JP); Tatsushi DOMON, Kariya-city (JP)

(21) Appl. No.: 17/015,459

(22) Filed: Sep. 9, 2020

Related U.S. Application Data
(63) Continuation of application No. PCT/JP2019/009086, filed on Mar. 7, 2019.

(30) Foreign Application Priority Data
Mar. 13, 2018 (JP) 2018-045704

(51) Int. Cl. B60H 1/22; H05B 1/02; H05B 3/26; B60R 16/03

(52) U.S. Cl. CPC B60H 1/2218; H05B 1/0236; B60R 16/03; H05B 3/26; H05B 1/0202

(57) ABSTRACT

A heater apparatus includes a heat generating unit, an outer surface, a temperature sensor and a detection unit. A first control portion of an electronic control unit controls temperature of the heat generating unit in such a way that it stops or reduces electric power supply to the heat generating unit, when it determines that an object has been brought into contact with a first region of the outer surface. A second control portion of the electronic control unit controls the temperature of the heat generating unit depending on a detected temperature of the temperature sensor. A third control portion of the electronic control unit controls the temperature of the heat generating unit in such a way that it stops or reduces the electric power supply to the heat generating unit, when it determines that the object has been brought into contact with a second region of the outer surface.

### CROSS REFERENCE TO RELATED APPLICATION

The present application is a continuation application of International Patent Application No. PCT/JP2019/009086 filed on Mar. 7, 2019, which designates the U.S. and claims the benefit of priority from Japanese Patent Application No. 2018-045704 filed on Mar. 13, 2018. The entire disclosure of the above application is incorporated herein by reference.

### FIELD OF TECHNOLOGY

The present disclosure relates to a heater apparatus for generating radiation heat upon receiving electrical power supply.

### BACKGROUND

In a heater apparatus of a prior art, an electric heater output to a heat generating portion is decreased or stopped, when a detection unit detects that an object has been brought into contact with or the object has come close to the heater apparatus, in order to suppress temperature increase of the object which has been brought into contact with or has come close to the heater apparatus.

However, the above prior art does not disclose anything about a temperature sensor, which detects the temperature of the heat generating portion to adjust the electric heater output to the heat generating portion. According to the investigations of the inventors of the present disclosure, a further development for the structure is necessary when providing a temperature sensor.

### SUMMARY OF THE DISCLOSURE

The present disclosure has an object to provide a heater apparatus, according to which a temperature sensor is appropriately provided and which controls a heat generating unit without adversely affecting detection of a contact of an object to the heater apparatus.

### BRIEF DESCRIPTION OF THE DRAWINGS

The above and other objects, features and advantages of the present disclosure will become more apparent from the following detailed description made with reference to the accompanying drawings. In the drawings:

FIG. 1 is a schematic view showing a heater apparatus according to a first embodiment of the present disclosure, which is provided in a passenger compartment of an automotive vehicle;

FIG. 2 is a schematic transparent view showing an inside structure of the heater apparatus of the first embodiment when viewed it in a thickness direction from a passenger side;

FIG. 3 is a schematic cross-sectional view taken along a line III-III in FIG. 2;

FIG. 4 is a block diagram showing an electrical structure of the heater apparatus of the first embodiment;

FIG. 5 is a flowchart showing a temperature control process carried out by an electronic control unit of FIG. 4;

FIG. 6 is a flowchart showing a contact detection process carried out by the electronic control unit of FIG. 4;

FIG. 7 is a timing chart showing a temperature of a heat generating unit, a detected temperature of a temperature sensor and an operating condition (an ON condition and an OFF condition) of the heat generating unit in its vertical axis, while a horizontal axis shows a time;

FIG. 8 is a schematic cross-sectional view showing a heater apparatus according to a first comparative example, wherein FIG. 8 is the cross-sectional view corresponding to FIG. 3;

FIG. 9 is a schematic cross-sectional view showing a heater apparatus according to a second comparative example, wherein FIG. 9 is the cross-sectional view corresponding to FIG. 3;

FIG. 10 is a schematic cross-sectional view showing a heater apparatus according to a third comparative example, wherein FIG. 10 is the cross-sectional view corresponding to FIG. 3;

FIG. 11 is a schematic transparent view showing the inside structure of the heater apparatus of a second embodiment when viewed it in the thickness direction from the passenger side;

FIG. 12 is a schematic cross-sectional view taken along a line XII-XII in FIG. 11;

FIG. 13 is a schematic cross-sectional view showing a cross-sectional structure of the heater apparatus according to a third embodiment, wherein FIG. 13 is the cross-sectional view corresponding to FIG. 3;

FIG. 14 is a timing chart showing a temperature of a heat generating unit and a detected temperature of a temperature sensor in its vertical axis, while a horizontal axis shows a time;

FIG. 15 is a schematic cross-sectional view showing a cross-sectional structure of the heater apparatus according to a fourth embodiment, wherein FIG. 15 is the cross-sectional view corresponding to FIG. 3;

FIG. 16 is a schematically enlarged view showing a portion XVI in FIG. 15;

FIG. 17 is a block diagram showing an electrical structure of the heater apparatus of the fourth embodiment;

FIG. 18 is a schematic cross-sectional view showing a cross-sectional structure of the heater apparatus according to a fifth embodiment, wherein FIG. 18 is the cross-sectional view corresponding to FIG. 3;

FIG. 19 is a block diagram showing an electrical structure of the heater apparatus of the fifth embodiment;

FIG. 20 is a flowchart showing a temperature control process carried out by an electronic control unit of the fifth embodiment;

FIG. 21 is a flowchart showing a contact detection process carried out by the electronic control unit of the fifth embodiment;

FIG. 22 is a timing chart for the fifth embodiment showing a temperature in its vertical axis and a time in its horizontal axis, wherein FIG. 22 shows a temperature control range ATW of the heat generating unit and detected temperatures T1 and T2 of the temperature sensor;

FIG. 23 is a timing chart for the fifth embodiment showing a detected temperature of two temperature sensors in its vertical axis and a time in its horizontal axis, wherein FIG. 23 shows changes of the detected temperatures of the two temperatures when a passenger has touched the heater apparatus;

FIG. 24 is a schematic transparent view showing the inside structure of the heater apparatus of a sixth embodiment when viewed it in the thickness direction from the passenger side; and

FIG. 25 is a schematic cross-sectional view taken along a line XXV-XXV in FIG. 24.

### DETAILED DESCRIPTION OF THE EMBODIMENTS

Hereinafter, the embodiments of the present disclosure will be explained with reference to the drawings. The same reference numerals are given to the same or similar structures and/or portions throughout the multiple embodiments and explanation thereof will be omitted.

### First Embodiment

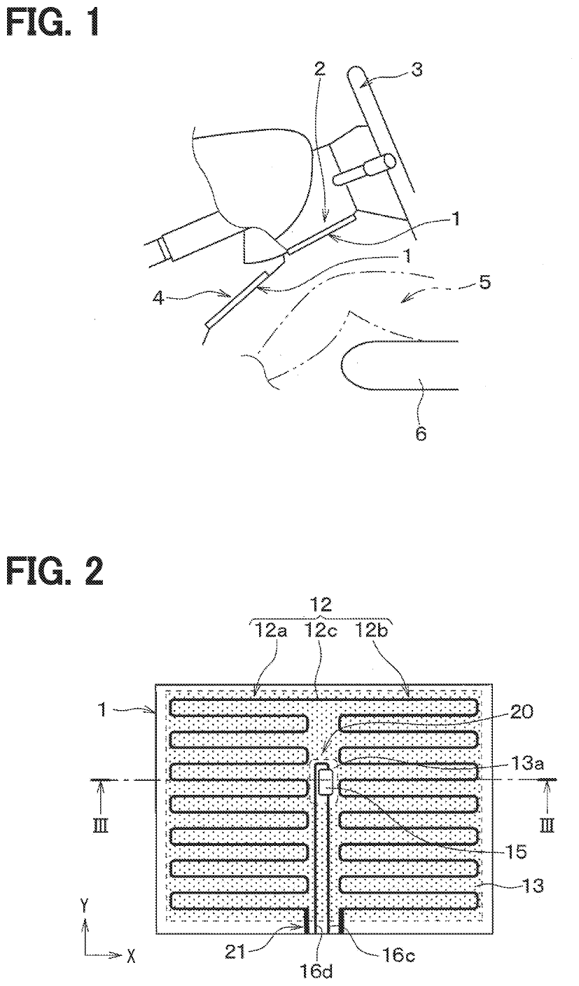

A first embodiment of a heater apparatus will be explained with reference to FIGS. 1 to 10.

In FIG. 1, the heater apparatus 1 of the present embodiment forms a part of a heating system for heating a passenger compartment of an automotive vehicle. The heater apparatus 1 is an electric heater device, which generates heat when it receives electric power from a battery or a generator mounted in the automotive vehicle.

The heater apparatus 1 of the present embodiment is located at a lower side of a steering column 2 supporting a steering wheel 3 in the passenger compartment or at a lower side of an instrument panel 4 in such a way that the heater apparatus 1 is opposed to an object, that is, a leg portion of a passenger 5 including an upper leg, a knee, a shank or the like. FIG. 1 shows a condition that the passenger 5 sits on a driver's seat 6.

The heater apparatus 1 generates heat when the electric power is supplied thereto. The heater apparatus 1 emits radiation heat in a direction perpendicular to an outer surface 14a of the heater apparatus 1 in order to warm the object, which is located at a position in the direction perpendicular to the outer surface 14a.

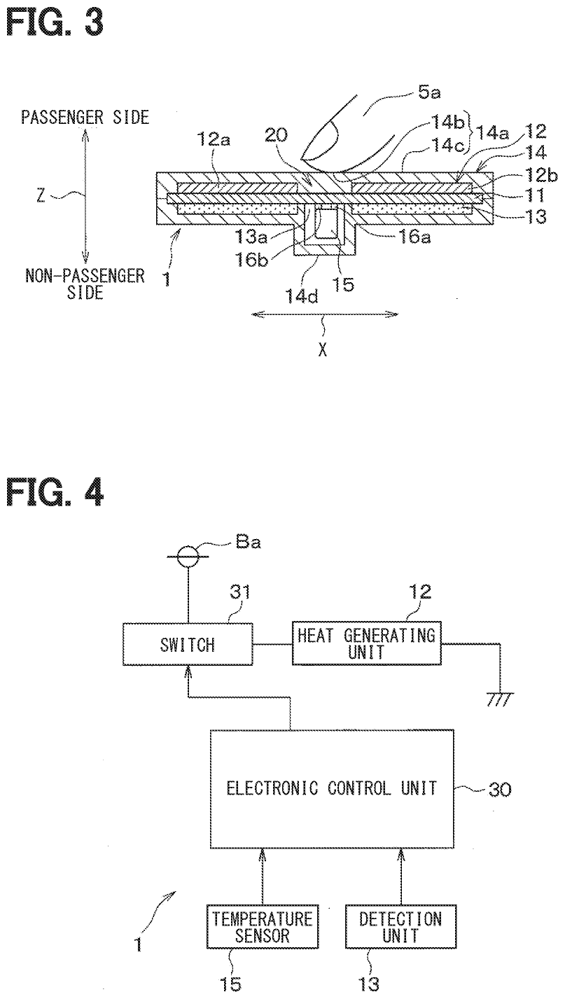

A detailed structure of the heater apparatus 1 will be explained with reference to FIGS. 2 and 3. In FIGS. 2 and 3, a Z-direction is a thickness direction and each of an X-direction and a Y-direction is perpendicular to the Z-direction. The heater apparatus 1 is formed in a thin plate shape extending along an X-Y plane, which is defined by the X-direction and the Y-direction. The X-direction is defined as a second direction.

The Z-direction corresponds to a direction, in which the outer surface 14a and a heat generating unit 12 of the heater apparatus 1 are connected to each other. For the purpose of convenience, a side of the heater apparatus 1 in the Z-direction on which the leg portion of the passenger is located as the object is referred to as a passenger side, while an opposite side in the Z-direction to the passenger is referred to as a non-passenger side.

The heater apparatus 1 is formed in a rectangular form, when viewed it in the Z-direction. The heater apparatus 1 includes an insulating substrate 11, the heat generating unit 12, a detection unit 13, an insulating layer 14, a temperature sensor 15 and electrodes 16a and 16b.

The insulating substrate 11 is made of electrical insulating material, for example, resin material or the like and formed in a thin film form extending along the X-Y plane. The temperature sensor 15, the detection unit 13 and the heat generating unit 12 are mounted to the insulating substrate 11. The heat generating unit 12 is located on the passenger side of the insulating substrate 11 in the Z-direction. The heat generating unit 12 includes meandering portions 12a and 12b.

Each of the meandering portions 12a and 12b is composed of a heat generating body of a linear shape, which is formed in a meandering shape. The meandering portions 12a and 12b are arranged at a distance in the X-direction. The meandering portions 12a and 12b are connected to each other by a connecting portion 12c. The connecting portion 12c is located at a position in an area between the meandering portions 12a and 12b and on one side thereof in the Y-direction (more exactly, in an upper-side area in FIG. 2).

An intermediate area 20 is formed in the area between the meandering portions 12a and 12b on a side opposite to the connecting portion 12c in the Y-direction (more exactly, in a lower-side area in FIG. 2), in which the heat generating unit 12 is not formed.

In the present embodiment, the heat generating unit 12 is formed on the insulating substrate 11 by a vapor deposition process, a printing process or the like. The heat generating unit 12 is made of metal or alloy, which include an alloy of copper and tin (Cu—Sn), silver, tin, stainless steel, nickel, nichrome and so on.

The detection unit 13 is located on a side of the heat generating unit 12 opposite to the outer surface 14a in the Z-direction. In other words, the detection unit 13 is located on the non-passenger side of the insulating substrate 11 in the Z-direction. The detection unit 13 is formed in the thin film form in such a way that it extends along the insulating substrate 11. The detection unit 13 forms a capacitor, which has a pair of electrodes and an insulating body between the electrodes.

In the present embodiment, the detection unit 13 forms a close-range sensor of a capacitance type, which detects a detection object (for example, a finger 5a of the passenger) by a change of electrostatic capacitance when the detection object comes closer to the detection unit 13. The detection unit 13 is formed on the insulating substrate 11 by the vapor deposition process, the printing process or the like.

A sensor hole 13a is formed at a center of the detection unit 13 in the X-direction, which is opened to the non-passenger side in the Z-direction. In other words, a portion which is the center of the detection unit 13 and at which the detection unit 13 is not formed is formed as the sensor hole 13a on the non-passenger side of the insulating substrate 11 in the Z-direction. The sensor hole 13a is formed in such a way that it overlaps with the intermediate area 20 in the Z-direction.

The temperature sensor 15 is located on a side of the heat generating unit 12 opposite to the outer surface 14a in the Z-direction. In other words, the temperature sensor 15 is located on the side of the insulating substrate 11 of the non-passenger side in the Z-direction. The temperature sensor 15 is offset from the detection unit 13 in the X-direction. The temperature sensor 15 is provided in the sensor hole 13a. In the present embodiment, the temperature sensor 15 is composed of a thermistor.

In the present embodiment, the insulating substrate 11 is arranged between the temperature sensor 15 as well as the detection unit 13 and the heat generating unit 12.

The electrodes 16a and 16b are located on the non-passenger side of the insulating substrate 11 in the Z-direction. The electrodes 16a and 16b are located at positions, which overlap with the intermediate portion 20 in the Z-direction. The electrodes 16a and 16b are made of conductive metal material, such as copper or the like.

The electrodes 16a and 16b are wiring patterns formed on the insulating substrate 11 by the vapor deposition process, the printing process or the like. The electrodes 16a and 16b and the temperature sensor 15 are connected to each other by solder material.

The electrodes 16a and 16b form electrodes for the temperature sensor 15 (namely, temperature-sensor electrodes). The electrodes 16a and 16b are located between the temperature sensor 15 and the insulating substrate 11.

Each of the electrodes 16a and 16b forms a part of wirings for transmitting a detected signal of the temperature sensor 15 to an electronic control unit 30 via wirings 16c and 16d. The wirings 16c and 16d are located on the side of the insulating substrate 11 of the non-passenger side in the Z-direction.

The wiring 16c is connected to the electrode 16a. The wiring 16d is connected to the electrode 16b. Each of the wirings 16c and 16d is formed in the thin film form extending along the insulating substrate 11. The wirings 16c and 16d are made of conductive material, such as, copper or the like. The wirings 16c and 16d are wiring patterns formed on the insulating substrate 11 by the vapor deposition process, the printing process or the like.

As above, the heat generating unit 12 is formed on the passenger side of the insulating substrate 11 in the Z-direction, while the electrodes 16a and 16b of the temperature sensor 15, the wirings 16c and 16d and the detection unit 13 are formed on the non-passenger side of the insulating substrate 11 in the Z-direction.

In the present embodiment, the insulating substrate 11, the heat generating unit 12, the electrodes 16a and 16b of the temperature sensor 15, the wirings 16c and 16d and the detection unit 13 are formed as one integral product. In other words, a circuit board, to which the heat generating unit 12, the electrodes 16a and 16b of the temperature sensor 15 and the detection unit 13 are integrally mounted, is formed.

In the present embodiment, a connector 21 is formed at a center of the insulating substrate 11 in the X-direction and at one end of the insulating substrate 11 in the Y-direction (more exactly, at a lower side position in FIG. 2) for connecting the heat generating unit 12 and the wirings 16c and 16d to the electronic control unit 30.

The insulating layer 14 is formed in the thin film shape in such a way that it covers the insulating substrate 11, the heat generating unit 12, the detection unit 13, the temperature sensor 15 and the electrodes 16a and 16b from their outsides. The insulating layer 14 of the present embodiment is made of electrical insulating material. A surface of the insulating layer 14 on the passenger side in the Z-direction forms the outer surface 14a, which is opposed to the detection object, that is, the leg portion of the passenger 5 including the upper leg, the knee, the shank and so on.

The insulating layer 14 of the present embodiment has a sensor cover portion 14d, which covers the temperature sensor 15 from the non-passenger side in the Z-direction.

An electrical structure of the heater apparatus 1 of the present embodiment will be explained with reference to FIG. 4. The heater apparatus 1 includes the electronic control unit 30 and a switch 31.

The electronic control unit 30, which includes a memory device, a micro-computer and so on, carries out a temperature control process (explained below) for the heat generating unit 12 and a contact detection process (explained below) in accordance with computer programs memorized in the memory device. The memory device is composed of a storage medium of a non-transition type.

The electronic control unit 30 controls the heat generating unit 12 via the switch 31 based on detected values of the temperature sensor 15 and the detection unit 13, when executing the temperature control process and the contact detection process.

The switch 31 is composed of a transistor, a relay switch or the like. The switch 31 connects a plus-side electrode of a battery Ba to the heat generating unit 12 or cuts off the electrical connection between them. The switch 31 and the heat generating unit 12 are connected in series with each other and provided between the plus-side electrode of the battery Ba and ground.

The electronic control unit 30 alternately carries out the temperature control process and the contact detection process. Hereinafter, the temperature control process and the contact detection process will be respectively explained.

### (Temperature Control Process)

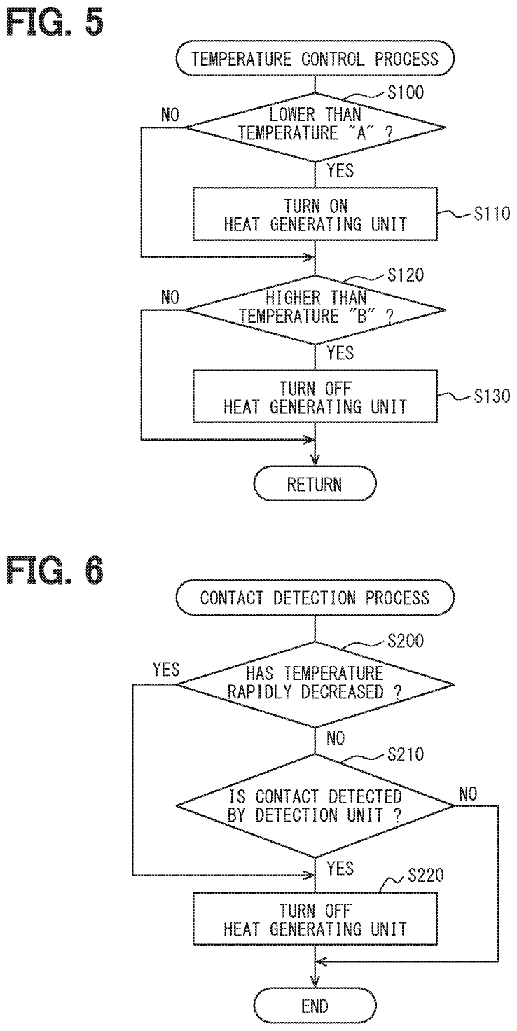

The electronic control unit 30 carries out the temperature control process in accordance with a flowchart of FIG. 5.

At first, the electronic control unit 30 determines at a step S100 based on the detected value of the temperature sensor 15 whether temperature of the heat generating unit 12 is lower than a temperature “A” or not.

The electronic control unit 30 determines YES at the step S100, when the temperature of the heat generating unit 12 is lower than the temperature “A”. Then, the electronic control unit 30 controls the switch 31 at a step S110 in such a way that the plus-side electrode of the battery Ba is connected to the heat generating unit 12. Namely, the heat generating unit 12 is turned on via the switch 31.

Electric current thereby flows from the battery Ba to the ground via the switch 31, the meandering portion 12a of the heat generating unit 12, the connecting portion 12c and the meandering portion 12b. Heat is therefore generated at the meandering portion 12a, the connecting portion 12c and the meandering portion 12b.

As above, the heat is generated when the electric power is supplied to the heat generating unit 12. The heat is emitted as radiation heat to the upper leg, the knee and the shank of the passenger 5. The temperature at the heat generating unit 12 is increased in accordance with the generation of the heat by the heat generating unit 12.

At a step S120, the electronic control unit 30 determines based on the detected value of the temperature sensor 15 whether the temperature of the heat generating unit 12 is higher than a temperature “B” or not. A temperature higher than the temperature “A” is set at a value of the temperature “B”.

The electronic control unit 30 determines NO, when the temperature of the heat generating unit 12 is lower than the temperature “B”. Then, the process goes back to the step S100, while the switch 31 is maintained in a turn-on condition.

When a condition that the temperature of the heat generating unit 12 is higher than the temperature “A” and the temperature of the heat generating unit 12 is lower than the temperature “B” is continued, the determination of NO at the step S100 and the determination of NO at the step S120 are repeated. Therefore, the condition that the plus-side electrode of the battery Ba is connected to the heat generating unit 12 is continued. As a result, the heat generating unit 12, to which the electric power is continuously supplied, continuously generates the heat.

When the temperature of the heat generating unit 12 thereafter becomes higher than the temperature “B”, the switch 31 is so controlled at a step S130 that the connection between the plus-side electrode of the battery Ba and the heat generating unit 12 is cut off. In other words, the heat generating unit 12 is turned off by the switch 31.

Current flow from the battery Ba to the ground via the switch 31 and the heat generating unit 12 is stopped. The generation of the heat at the heat generating unit 12 is thereby stopped. The heat radiation from the outer surface 14a is thereby stopped. As a result, the temperature of the heat generating unit 12 is decreased.

As above, the electric power supply to the heat generating unit 12 is controlled by turning on and off depending on the temperature of the heat generating unit 12. The radiation heat from the heat generating unit 12 is thereby generated intermittently. As a result, the temperature of the heat generating unit 12 converges to a predetermined range.

### (Contact Detection Process)

The electronic control unit 30 carries out the contact detection process in accordance with a flowchart of FIG. 6.

At first, at a step S200, the electronic control unit 30 determines whether the detected value of the temperature sensor 15 is decreased by more than a predetermined temperature “Ta” within a predetermined time. In other words, the electronic control unit 30 determines whether the detected value of the temperature sensor 15 has rapidly decreased or not.

In other words, the electronic control unit 30 determines whether an amount of change “ΔT (=T1−T2)” is larger than a predetermined temperature “Ta” or not, when the detected temperature of the temperature sensor 15 is decreased in the predetermined time. The amount of change “ΔT” is a difference between a maximum detected temperature “T1” and a minimum detected temperature “T2” of the temperature sensor 15.

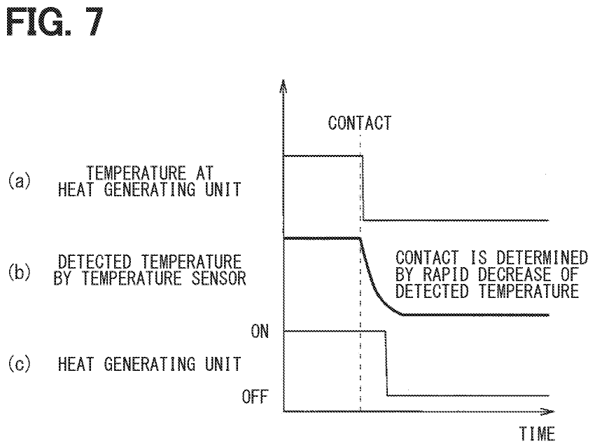

For example, when the finger 5a of the passenger is brought into contact with an overlapping area 14b, which is a part of the outer surface 14a and overlaps with the sensor hole 13a in the Z-direction, the heat transfers from an inside of the sensor hole 13a (for example, the temperature sensor 15) to the finger 5a of the passenger via the overlapping area 14b of the outer surface 14a. The overlapping area 14b is the part of the outer surface 14a, which overlaps with the temperature sensor 15 in the Z-direction. Therefore, when the finger 5a of the passenger is brought into contact with the overlapping area 14b, the detected temperature of the temperature sensor 15 rapidly decreases (please see FIG. 7(b)).

In FIG. 7(b), a vertical axis shows the detected temperature of the temperature sensor 15, while a horizontal axis shows time. FIG. 7(b) shows that the detected temperature of the temperature sensor 15 rapidly decreases, when the finger 5a of the passenger is brought into contact with the outer surface 14a.

Since the amount of change “ΔT” of the detected temperature of the temperature sensor 15 in the predetermined time is larger than the predetermined temperature “Ta”, the electronic control unit 30 determines YES at the step S200. Then, at a step S220, the switch 31 is so controlled that the connection between the plus-side electrode of the battery Ba and the heat generating unit 12 is cut off. In other words, the heat generating unit 12 is turned off by the switch 31.

The current flow from the battery Ba to the ground via the switch 31 and the heat generating unit 12 is stopped. The heat generation at the heat generating unit 12 is thereby stopped. The heat radiation from the outer surface 14a is thereby stopped. The temperature of the heat generating unit 12 is finally decreased.

On the other hand, the electronic control unit 30 determines NO at the step S200, when one of the following conditions (a), (b) and (c) is satisfied:

(a) the detected temperature of the temperature sensor 15 is increased in the predetermined time;

(b) the detected temperature of the temperature sensor 15 is constant in the predetermined time; or

(c) the detected temperature of the temperature sensor 15 is decreased in the predetermined time and the amount of change “ΔT” of the temperature sensor 15 is smaller than the predetermined temperature “Ta”.

In the above case, the process goes to a step S210 and the electronic control unit 30 determines based on a detected value of the detection unit 13 whether the finger 5a of the passenger 5 has been brought into contact with an overlapping area 14c or not (or whether the finger 5a has come closer to the overlapping area 14c), which is a part of the outer surface 14a and overlaps with the detection unit 13 in the Z-direction. The overlapping area 14c corresponds to a first region.

The electrostatic capacitance of the detection unit 13 is rapidly increased, when the finger 5a of the passenger is brought into contact with (or comes closer to) the overlapping area 14c, which is the part of the outer surface 14a and overlaps with the detection unit 13 in the Z-direction.

In the present embodiment, the electronic control unit 30 determines whether or not the electrostatic capacitance of the detection unit 13 is changed by more than a predetermined amount “Cs” in the predetermined time.

The electronic control unit 30 determines YES at the step S210, when the electrostatic capacitance of the detection unit 13 is changed by more than the predetermined amount “Cs” in the predetermined time.

Then, at the step S220, the switch 31 is so controlled that the connection between the plus-side electrode of the battery Ba and the heat generating unit 12 is cut off. The heat generating unit 12 is turned off by the switch 31. The temperature of the heat generating unit 12 can be thereby decreased (please see FIGS. 7(a) and (c)).

In the present disclosure, the step S210 and the step S220 correspond to a first control portion. The steps of S100, S110, S120 and S130 correspond to a second control portion. The steps S200 and S220 correspond to a third control portion.

FIG. 7(a) is a timing chart, wherein a vertical axis shows the temperature of the heat generating unit 12, while a horizontal axis shows the time. FIG. 7(c) is a timing chart, wherein a vertical axis shows an operating condition of the heat generating unit 12 (a turned-on condition and a turned-off condition), while a horizontal axis shows the time.

As explained above, the finger 5a of the passenger is occasionally brought into contact with or it comes closer to the overlapping area 14c, which is the part of the outer surface 14a and overlaps with the detection unit 13. In addition, the finger 5a of the passenger is occasionally brought into contact with the overlapping area 14b, which is the part of the outer surface 14a and overlaps with the sensor hole 13a. In such a case, the heat generating unit 12 is turned off by the switch 31 at the step S220.

On the other hand, an amount of change of the electrostatic capacitance of the detection unit 13 becomes smaller than the predetermined amount “Cs”, when the finger 5a of the passenger is separated from the overlapping area 14c of the outer surface 14a, which overlaps with the detection unit 13. Therefore, the electronic control unit 30 determines NO at the step S210. The contact detection process goes to an end.

According to the above explained embodiment, the heater apparatus 1 includes the heat generating unit 12 for generating the radiation heat upon receiving the electric power and the outer surface 14a for emitting the radiation heat from the heat generating unit 12 to the passenger. The direction for connecting the heat generating unit 12 to the outer surface 14a is defined as the Z-direction. The Z-direction corresponds to a first direction.

The heater apparatus 1 includes the detection unit 13, which is located on the side of the heat generating unit 12 opposite to the outer surface 14a and which is located at the overlapping area 14c of the outer surface 14a overlapping with the detection unit 13 in the Z-direction. The detection unit 13 detects whether the finger 5a of the passenger is brought into contact with the outer surface 14a. The heater apparatus 1 includes the electronic control unit 30.

The electronic control unit 30 terminates the electric power supply to the heat generating unit 12, when it determines based on a detection signal (=the detected value) of the detection unit 13 that the finger 5a of the passenger has been brought into contact with the overlapping area 14c (at the steps S210 and S220).

The heater apparatus 1 includes the temperature sensor 15, which is located on the side of the heat generating unit 12 opposite to the outer surface 14a, which is offset from the detection unit 13 in the X-direction, and which detects the temperature of the heat generating unit 12. The directions perpendicular to the Z-direction are respectively defined as the Y-direction and the X-direction. The electronic control unit 30 controls the temperature of the heat generating unit 12 based on the detected temperature of the temperature sensor 15 (at the steps S100 to S130).

The part of the area of the heat generating unit 12, which is located between the meandering portions 12a and 12b and on the side of the connecting portion 12c in the Y-direction, is defined as the intermediate area 20. The temperature sensor 15 is located at the position, at which it overlaps with the intermediate area 20 in the Z-direction.

The electronic control unit 30 determines based on the detected temperature of the temperature sensor 15 whether the finger 5a of the passenger has been brought into contact with the overlapping area 14b, which is the part of the outer surface 14a and overlaps with the temperature sensor 15 in the Z-direction.

The electronic control unit 30 terminates the electric power supply to the heat generating unit 12, when it determines that the detection object has been brought into contact with the overlapping area 14b (at the steps S200 and S220).

The applicant considered the various positions of the temperature sensor 15 and compared the present embodiment with the following cases (d), (e) and (f).

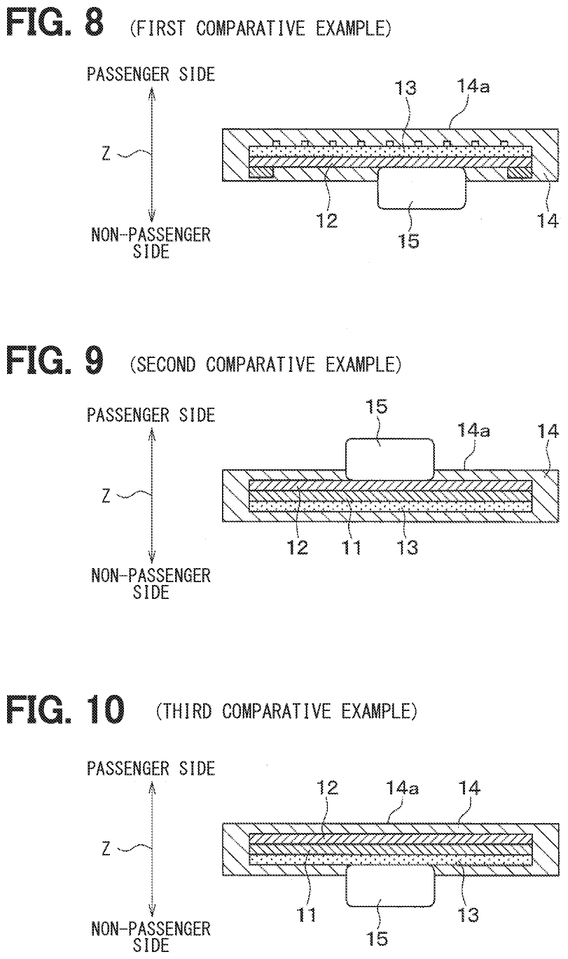

(d) In a case that the detection unit 13 is provided on the passenger side in the Z-direction and the heat generating unit 12 is provided on the non-passenger side, as shown in FIG. 8 (a first comparative example), the detection unit 13 is located between the heat generating unit 12 and the outer surface 14a. Since the radiation heat is transmitted from the heat generating unit 12 to the outer surface 14a, the temperature of the radiation heat is decreased between them and thereby a heating performance is decreased.

In the example of FIG. 8, the temperature sensor 15 is provided on the non-passenger side of the heat generating unit 12. Therefore, the temperature sensor 15 can detect the temperature of the heat generating unit 12 with high accuracy. It is thereby possible to maintain a good controllability for the temperature control of the heat generating unit 12. In addition, it is possible to obtain a good-looking of the heater apparatus 1 due to the position of the temperature sensor 15 located on the non-passenger side.

(e) In a second comparative example of FIG. 9, the temperature sensor 15 is provided on the passenger side of the heat generating unit 12 in the Z-direction. In this example, it is possible to detect the temperature of the heat generating unit 12 by the temperature sensor 15 with high accuracy. Although It is possible to maintain the good controllability for the temperature control of the heat generating unit 12, an appearance of the outer surface 14a is deteriorated by the thickness of the temperature sensor 15, namely by a surface asperity of the outer surface 14a.

In the example of FIG. 9, the heat generating unit 12 is located on the non-passenger side of the outer surface 14a via the insulating layer 14 in the Z-direction. It is thereby possible to make smaller a distance between the heat generating unit 12 and the outer surface 14a. Since it is possible to suppress the temperature decrease, a high heating performance can be obtained.

(f) In a third comparative example of FIG. 10, the detection unit 13 and the temperature sensor 15 are provided on the non-passenger side of the heat generating unit 12 in the Z-direction. Since the detection unit 13 is provided between the heat generating unit 12 and the temperature sensor 15, the detected temperature of the temperature sensor 15 for the heat generating unit 12 becomes detached from an actual temperature. It is therefore difficult to ensure the accuracy for the temperature controllability.

In the example of FIG. 10, the heat generating unit 12 is located on the non-passenger side of the outer surface 14a in the Z-direction via the insulating layer 14. Therefore, in the same manner to the above example (e), a high heating performance can be obtained.

As above, in each of the structures of FIGS. 8 to 10, it is difficult to satisfy at the same time all requirements for the temperature controllability, the heating performance and the good appearance, without adversely affecting the detection of the contact between the detection object and the heater apparatus.

According to the present embodiment, however, the heat generating unit 12 is located on the non-passenger side of the outer surface 14a in the Z-direction via the insulating layer 14. It is thereby possible to make smaller the distance between the heat generating unit 12 and the outer surface 14a. It is therefore possible to effectively transfer the heat from the heat generating unit 12 to the outer surface 14a. It is possible to obtain a heat quantity of the radiation heat emitted from the outer surface 14a. As a result, it is possible to ensure the high heating performance.

In addition to the above point, in the present embodiment, the detection unit 13 is located on the non-passenger side of the heat generating unit 12 in the Z-direction. The temperature sensor 15 is provided in the sensor hole 13a of the detection unit 13 (in other words, at the position where no detection unit 13 is formed).

Since it is possible in the present embodiment to make smaller the distance between the heat generating unit 12 and the temperature sensor 15, it is possible to accurately detect the temperature of the heat generating unit 12. It is thereby possible to ensure the good temperature controllability for the heat generating unit 12.

In addition, since the temperature sensor 15 is located on the non-passenger side of the heat generating unit 12 in the Z-direction, it is avoided that the outer surface 14a becomes a concavo-convex shape by the temperature sensor 15. The good appearance can be obtained, when viewed the outer surface 14a of the heater apparatus 1 from the passenger side in the Z-direction.

As above, since the temperature sensor 15 is provided at the proper position in the present embodiment, it is possible to provide the heater apparatus 1, which satisfies at the same time all of the requirements for the temperature controllability, the heating performance and the appearance, without adversely affecting the detection of the detection object for its contact condition or proximity condition.

In the present embodiment, the insulating substrate 11, the heat generating unit 12, the electrodes 16a and 16b for the temperature sensor 15 and the detection unit 13 are formed as one integral product. It is therefore possible to reduce a number of parts and a manufacturing cost, when compared with a case, in which the insulating substrate 11, the heat generating unit 12, the electrodes 16a and 16b for the temperature sensor 15 and the detection unit 13 are separately manufactured from one another.

### Second Embodiment

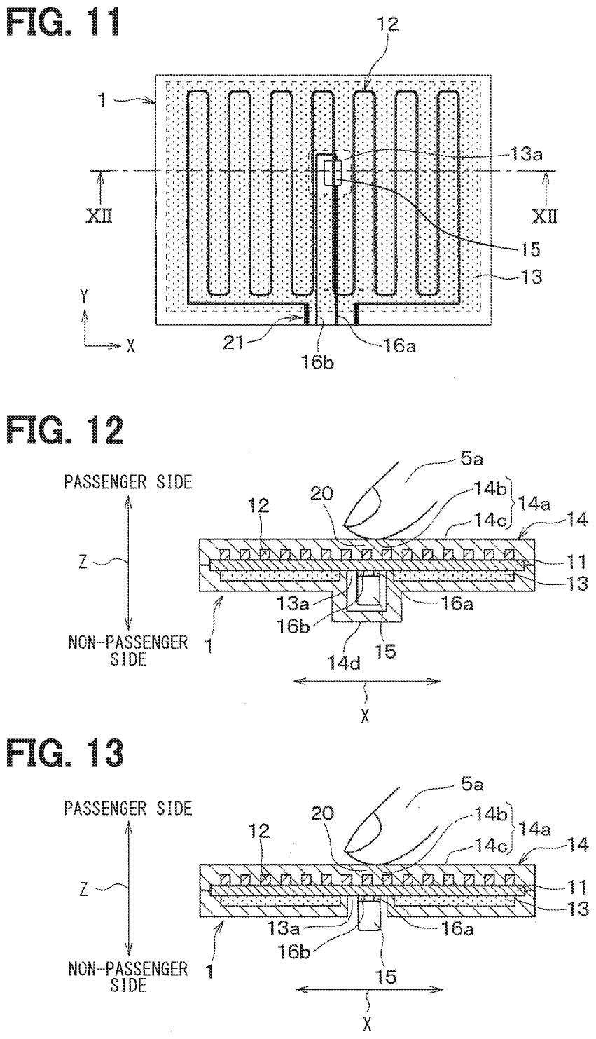

In the first embodiment, the temperature sensor 15 is located in such a way that it overlaps with the intermediate portion 20 between the meandering portions 12a and 12b of the heat generating unit 12. A second embodiment, according to which the temperature sensor 15 is located in the following manner, will be explained with reference to FIGS. 11 and 12.

In the heater apparatus 1 of the present embodiment, the temperature sensor 15 is located in such a way that it overlaps with the heat generating unit 12 in the Z-direction. When compared with the first embodiment, it is possible in the present embodiment to make shorter the distance between the heat generating unit 12 and the temperature sensor 15. It is therefore possible to more accurately detect the temperature of the heat generating unit 12 by the temperature sensor 15. It is thereby possible to control the temperature of the heat generating unit 12 by the electronic control unit 30 with high accuracy.

The heat generating unit 12 of the present embodiment is composed of one meandering portion.

### Third Embodiment

In the above embodiments, the sensor cover portion 14d is formed as a part of the insulating layer 14, which covers the temperature sensor 15 from the non-passenger side in the Z-direction. A third embodiment, according to which the sensor cover portion 14d is eliminated, will be explained with reference to FIG. 13.

In the heater apparatus 1 of the present embodiment, the sensor cover portion 14d of FIG. 3 is eliminated. As shown in FIG. 13, the insulating layer 14 is so formed that the temperature sensor 15 is exposed to an outside on the non-passenger side in the Z-direction.

In the case of this embodiment, heat capacity of the inside of the sensor hole 13a (that is, a surrounding portion for the temperature sensor 15) becomes smaller than that of the first embodiment. A large amount of the heat moves in a short time from the overlapping area 14b of the outer surface 14a to the finger 5a of the passenger, when the finger 5a of the passenger is brought into contact with the overlapping area 14b of the outer surface 14a, which overlaps with the sensor hole 13a.

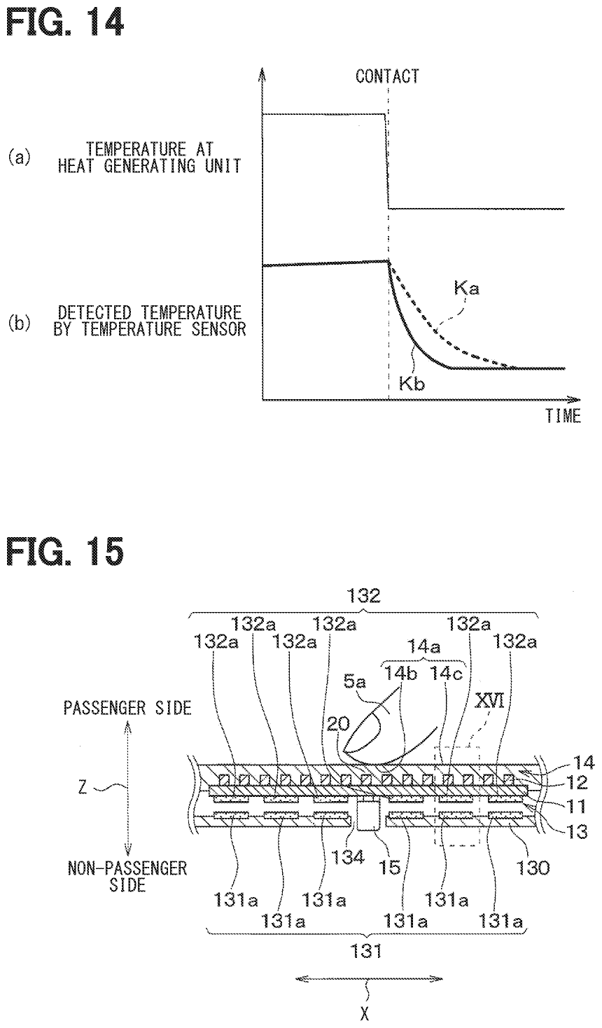

As indicated by characteristic lines “Ka” and “Kb” in FIG. 14, the detected temperature of the temperature sensor 15 is largely decreased in a short time, when compared with the first embodiment. Accordingly, it is possible to increase detection sensitivity, when the finger 5a of the passenger is brought into contact with the overlapping area 14b of the outer surface 14a.

Each of the characteristic lines “Ka” and “Kb” in FIG. 14 shows a change of the detected temperature of the temperature sensor 15 after the finger 5a of the passenger is brought into contact with the overlapping area 14b of the outer surface 14a. The characteristic line “Ka” shows the detected temperature of the temperature sensor 15 in the case that the sensor cover portion 14d is formed. The characteristic line “Kb” shows the detected temperature of the temperature sensor 15 in the case that the sensor cover portion 14d is not formed.

### Fourth Embodiment

In the above first to third embodiments, the contact condition or the proximity condition of the detection object is detected by the detection unit 13 based on the change of the electrostatic capacitance.

A fourth embodiment, according to which the contact condition and the non-contact condition of the detection object is detected by the detection unit 13 based on an on-state or an off-state of a switch, will be explained with reference to FIGS. 15 to 17.

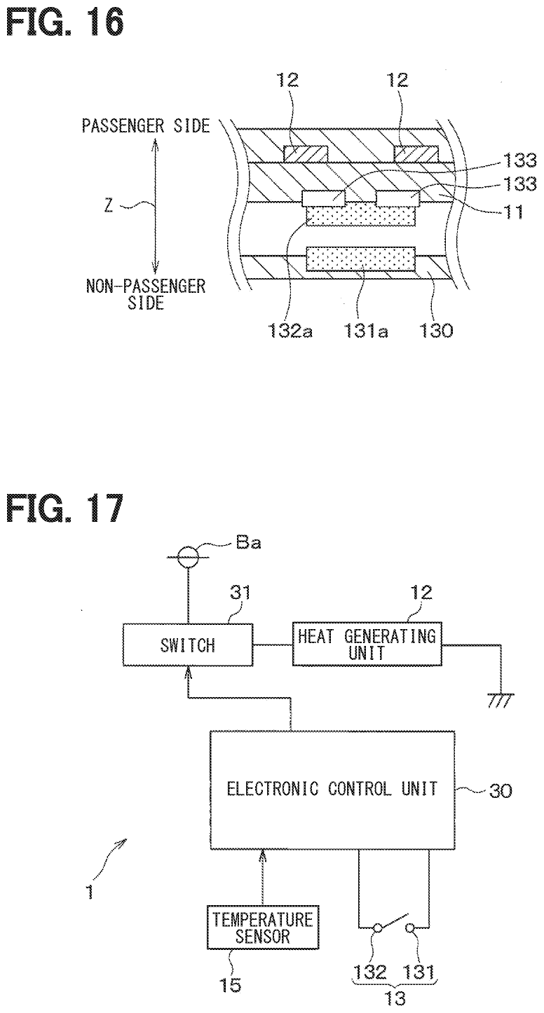

FIGS. 15 and 16 show a detailed structure of the detection unit 13 of the heater apparatus 1 of the present embodiment. The detection unit 13 of the present embodiment includes a fixed substrate 130, a fixed contact portion 131 and a movable contact portion 132.

The movable contact portion 132 includes multiple movable contact points 132a. Each of the movable contact points 132a is located on the non-passenger side of the insulating substrate 11 in the Z-direction. The multiple movable contact points 132a are arranged along the insulating substrate 11 in each of the X-direction and the Y-direction.

Each of the movable contact points 132a is connected to each of detection electrodes 133 by solder. The detection electrode 133 is located on the non-passenger side of the insulating substrate 11 in the Z-direction. The detection electrode 133 forms a part of the wirings for outputting the detection signal of the detection unit 13 to the electronic control unit 30.

Each of the detection electrodes 133 is made of conductive metal material, such as, copper or the like and formed in a thin film form extending along the insulating substrate 11. Each of the detection electrodes 133 is a wiring pattern, which is formed on the insulating substrate 11 by the vapor deposition process, the printing process or the like.

In the present embodiment, the insulating substrate 11, the heat generating unit 12, the electrodes 16a and 16b of the temperature sensor 15 and the detection electrodes 133 are formed as one integral product. In other words, a circuit board is formed, in which the heat generating unit 12, the electrodes 16a and 16b of the temperature sensor 15 and the detection electrodes 133 are integrally formed on the insulating substrate 11.

The fixed substrate 130 is located on the non-passenger side of the insulating substrate 11 in the Z-direction at a distance from the insulating substrate 11. The fixed substrate 130 is made of the electrical insulating material and formed in the thin film form extending along the insulating substrate 11.

The fixed contact portion 131 is composed of multiple fixed contact points 131a. Each of the fixed contact points 131a is located on the passenger side of the fixed substrate 130 in the Z-direction. Each of the fixed contact points 131a is supported by the fixed substrate 130. Each of the fixed contact points 131a is arranged in such a way that it is opposed to each of corresponding movable contact points 132a at the distance.

In the present embodiment, the fixed contact portion 131 (more exactly, the multiple fixed contact points 131a) and the movable contact portion 132 (more exactly, the multiple movable contact points 132a) form the switch 31 (FIG. 17), which is turned on or turned off depending on a condition that the finger 5a of the passenger is brought into contact with the outer surface 14a or not. The fixed substrate 130 and the insulating substrate 11 are supported by the insulating layer 14 in such a way that a gap is formed between the fixed substrate 130 and the insulating substrate 11.

A through-hole 134 is formed in the fixed substrate 130 for accommodating the temperature sensor 15. Therefore, it is possible to avoid a situation that the temperature sensor 15 may interfere with the fixed substrate 130 when the finger 5a of the passenger is brought into contact with the outer surface 14a of the heater apparatus 1 and thereby the insulating layer 14 is elastically deformed together with the insulating substrate 11.

In the heater apparatus 1 of the present embodiment having the above structure, the gap is formed between each of the fixed contact points 131a and each of the movable contact points 132a, when the finger 5a of the passenger is not in contact with the overlapping area 14c of the outer surface 14a. Therefore, the detection unit 13 working as the switch 31 is turned off.

On the other hand, when the finger 5a of the passenger is brought into contact with the overlapping area 14c of the outer surface 14a, a force of the finger 5a of the passenger is transmitted to the insulating layer 14 via the outer surface 14a and the heat generating unit 12. Then, the insulating substrate 11 is elastically deformed. One or some of the movable contact points 132a are displaced in the direction to the non-passenger side in the Z-direction and brought into contact with corresponding one or some of the fixed contact points 131a. The detection unit 13 working as the switch 31 is thereby turned on.

When the finger 5a of the passenger is separated from the overlapping area 14c of the outer surface 14a, the transmission of the force from the finger 5a of the passenger to the insulating substrate 11 is terminated. The elastically deformed insulating substrate 11 returns to its initial condition having no deformation. The one or some of the movable contact points 132a are displaced in the direction to the passenger side in the Z-direction. Therefore, the gap is formed again between the fixed contact point 131a and the movable contact point 132a. The detection unit 13 working as the switch 31 is turned off.

As above, the detection unit 13 is formed as the switch 31, which is turned on or turned off depending on the condition that the finger 5a of the passenger is in contact with the overlapping area 14c of the outer surface 14a or not.

According to the present embodiment above explained, the detection unit 13 forms the switch 31, which is turned on or turned off depending on the condition that the passenger 5 touches the outer surface 14a or not. The electronic control unit 30 can detect whether the passenger 5 has touched the outer surface 14a or not, based on the condition that the detection unit 13 is turned on or turned off.

In the present embodiment, the insulating substrate 11, the heat generating unit 12, the electrodes 16a and 16b of the temperature sensor 15 and the detection electrodes 133 are formed as one integral product. It is therefore possible to reduce a number of parts and a manufacturing cost, when compared with the case, in which the insulating substrate 11, the heat generating unit 12, the electrodes 16a and 16b for the temperature sensor 15 and the detection electrodes 133 are separately manufactured from one another.

### Fifth Embodiment

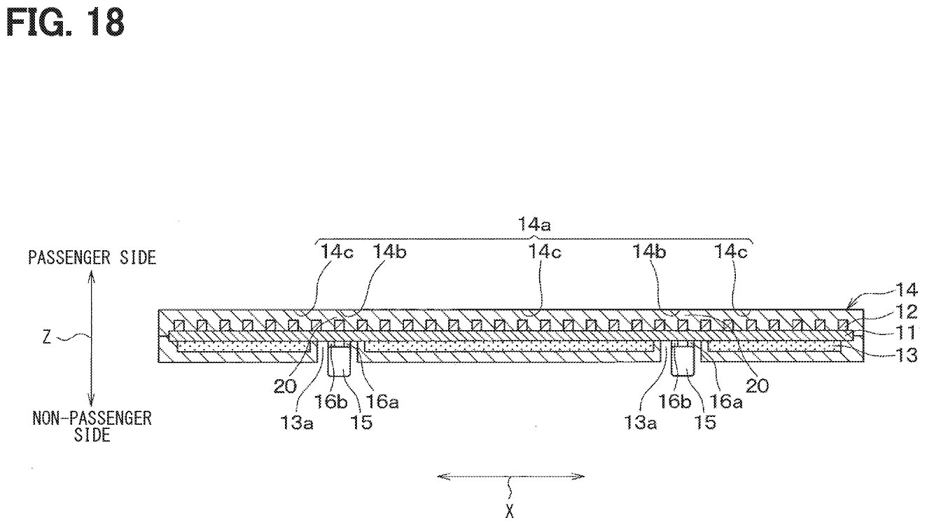

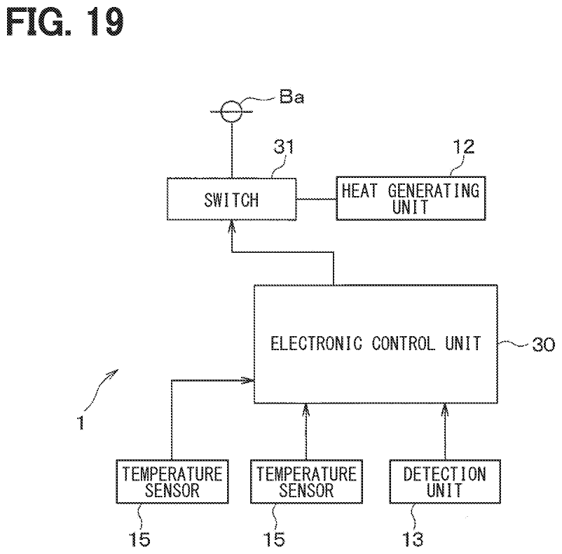

In the above first to fourth embodiments, one temperature sensor 15 is provided for one heat generating unit 12. A fifth embodiment, according to which two or more than two temperature sensors 15 are provided for one heat generating unit 12, will be explained with reference to FIGS. 18 to 23. One of the multiple sensors is defined as a first temperature sensor, while the other sensor is defined as a second temperature sensor.

Each of the two temperature sensors 15 for the heater apparatus 1 of the present embodiment is located on the non-passenger side of the insulating substrate 11 and the heat generating unit 12 in the Z-direction. Each of the two temperature sensors 15 is located on a side of the heat generating unit 12 opposite to the outer surface 14a. Each of the temperature sensors 15 is offset from the detection unit 13 in the X-direction. Each of the temperature sensors 15 is supported by the insulating substrate 11.

In the present embodiment, two sensor holes 13a are formed in the detection unit 13 in such a way that each of the sensor holes 13a is opened on the non-passenger side in the Z-direction. In other words, the detection unit 13 is not formed in each of an inside space of the sensor hole 13a.

One of the temperature sensors 15 is accommodated in one of the sensor holes 13a, while the other of the temperature sensors 15 is accommodated in the other of the sensor holes 13a.

Each of the temperature sensors 15 is offset from the detection unit 13 in the X-direction and in the Y-direction. In the present embodiment, two overlapping areas 14b are formed in the outer surface 14a, wherein each of the overlapping areas 14b overlaps with each of the sensor holes 13a.

According to the above structure, each of the temperature sensors 15 is arranged at a position, which is offset from the detection unit 13 in the X-direction and in the Y-direction.

The heater apparatus 1 of the present embodiment has such a structure, according to which the two temperature sensors 15 are provided instead of one temperature sensor 15 in the heater apparatus 1 of the above third embodiment. Therefore, since the structure of the heater apparatus 1 of the present embodiment other than the two temperature sensors 15 is substantially the same to that of the third embodiment, the explanation thereof is omitted.

An operation of the heater apparatus 1 of the present embodiment, which has the structure as explained above, will be explained hereinafter.

The electronic control unit 30 alternately carries out the temperature control process and the contact detection process. Each of the temperature control process and the contact detection process will be separately explained hereinafter.

### (Temperature Control Process)

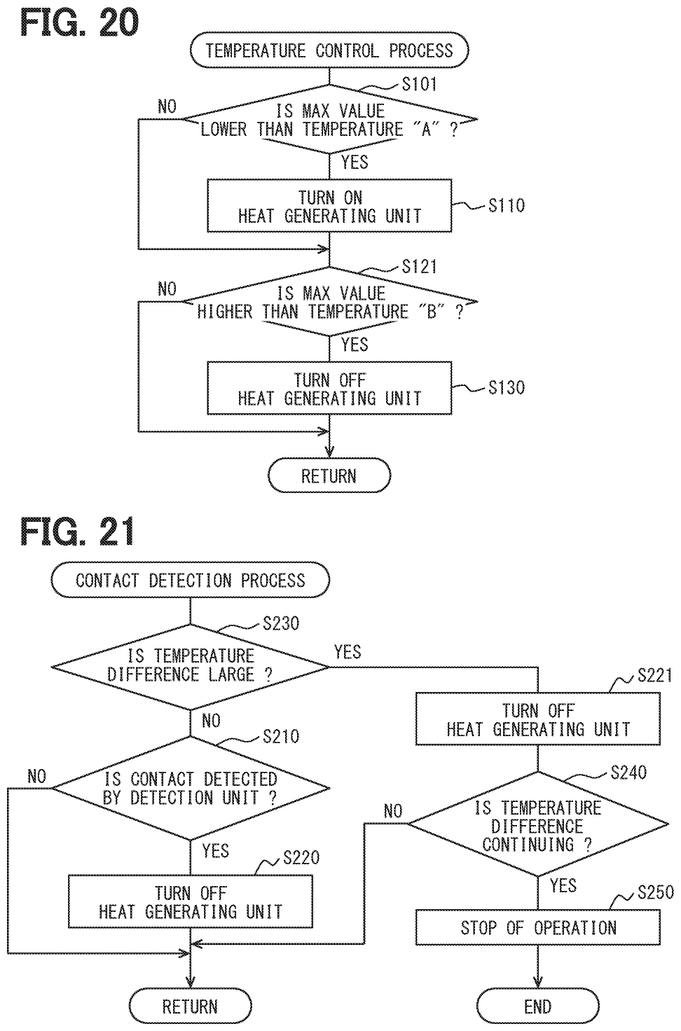

The electronic control unit 30 carries out the temperature control process in accordance with a flowchart of FIG. 20, which is a replacement for FIG. 5.

At first, at a step S101, the electronic control unit 30 determines based on detected signals of the two temperature sensors 15 whether one of the detected temperatures of the two temperature sensors 15, whichever is higher than the other (hereinafter, the max value), is lower than the temperature “A” or not.

In a case that the electronic control unit 30 determines YES at the step S101 when the max value is lower than the temperature “A”, the switch 31 is operated at the step S110 so that the plus-side electrode of the battery Ba is connected to the heat generating unit 12. In other words, the heat generating unit 12 is turned on via the switch 31.

Then, the electric current flows from the battery Ba to the ground via the switch 31 and the heat generating unit 12. The heat is thereby generated from the heat generating unit 12. The heat is emitted from the outer surface 14a as the radiation heat to the upper leg, the knee, the shank and so on of the passenger 5.

The temperature of the heat generating unit 12 is thereby increased.

The electronic control unit 30 determines, based on the detected temperatures of the two temperature sensors 15, at a step S121 whether the max value is higher than the temperature “B” or not. The temperature “B” is set at the value higher than the temperature “A”.

In a case that the electronic control unit 30 determines NO at the step S121 when the max value is lower than the temperature “B”, the process goes back to the step S101, while the on-condition of the switch 31 is maintained.

When the condition that the max value is higher than the temperature “A” and the max value is lower than the temperature “B” is continued, the determination of NO at the step S101 and the determination of NO at the step S121 are repeated. Therefore, the condition in that the plus-side electrode of the battery Ba is connected to the heat generating unit 12 via the switch 31 is continued. Since the electric power is continuously supplied to the heat generating unit 12, the heat generating unit 12 continuously generates the heat.

In a case that the max value thereafter becomes higher than the temperature “B” (YES at the step S121), the switch 31 is operated in such a way that the connection between the plus-side electrode of the battery Ba and the heat generating unit 12 is cut off (at the step S130). In other words, the heat generating unit 12 is turned off by the switch 31.

As a result, the current flow from the battery Ba to the ground via the switch 31 and the heat generating unit 12 is stopped. The heat radiation from the heat generating unit 12 is thereby stopped. The temperature of the heat generating unit 12 is thus decreased.

The current supply to the heat generating unit 12 is controlled by turning on or turning off the switch 31, depending on one of the detected temperatures of the two temperature sensors 15, whichever is higher than the other. The higher detected temperature is treated as a representing temperature of the heat generating unit 12.

On the other hand, in a case that the electronic control unit 30 controls the heat generating unit 12 depending on one of the detected temperatures of the two temperature sensors 15, whichever is lower than the other temperature, wherein the lower detected temperature is treated as the representing temperature of the heat generating unit 12, the following problem may occur.

For the purpose of convenience, one of the temperature sensors 15, which detects the lower temperature, is defined as a low-temperature sensor. In a case that temperature variation is generated on the outer surface 14a due to usage conditions of the heater apparatus 1, outside circumstances and so on, the actual temperature of such an area other than the area, the temperature of which is detected by the low-temperature sensor, is increased.

In the above case, the actual temperature of the heat generating unit 12 at a part of the area for the heat generating unit 12 (other than the area for the low-temperature sensor) may become higher than a predetermined temperature.

On the other hand, according to the present embodiment, the electronic control unit 30 controls the heat generating unit 12 by turning on or turning off the switch 31 depending on one of the detected temperatures of the two temperature sensors 15, whichever is higher than the other temperature, wherein the higher temperature is treated as the representing temperature of the heat generating unit 12.

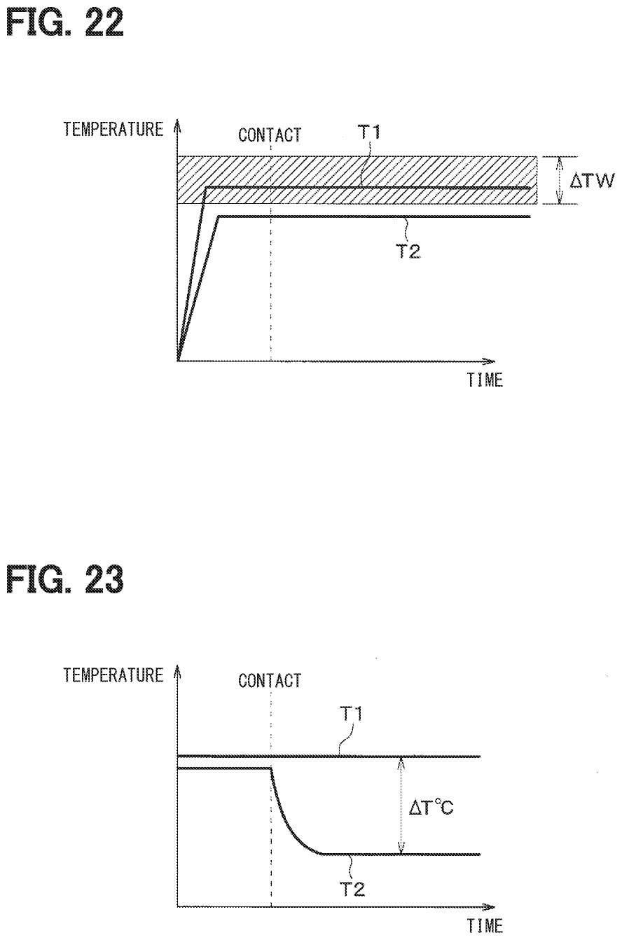

According to the above control, the actual temperature of the heat generating unit 12 converges to a temperature control range “ΔTW” (FIG. 22). Therefore, it is possible to avoid a situation that the actual temperature of the heat generating unit 12 may become higher than the predetermined temperature. Accordingly, it is possible to avoid a situation that thermally discomfort feeling may be given to the passenger by the high temperature condition beyond the predetermined temperature.

### (Contact Detection Process)

The electronic control unit 30 carries out the contact detection process in accordance with a flowchart of FIG. 21, which is a replacement for FIG. 6.

At first, at a step S230, the electronic control unit 30 determines whether a temperature difference between the detected temperatures of the two temperature sensors 15 (hereinafter, a detected temperature difference) is larger than a predetermined temperature “Tb” or not.

For example, in a case that the finger 5a of the passenger is brought into contact with one of the two overlapping areas 14b of the outer surface 14a, the heat moves from the overlapping area 14b of the outer surface 14a to the finger 5a of the passenger. In this case, the heat moves from the temperature sensor 15, which overlaps with the above one of the overlapping areas 14b in the Z-direction, to the finger 5a of the passenger via the overlapping area 14b of the outer surface 14a. As a result, the detected temperature of the temperature sensor 15, which overlaps with the above one of the overlapping areas 14b in the Z-direction, is rapidly decreased.

In the above case, the finger 5a of the passenger is not in contact with the other of the two overlapping areas 14b, which is the overlapping area 14b other than the above one overlapping area 14b. The detected temperature of the temperature sensor 15, which overlaps with the above other overlapping area 14b in the Z-direction, does not have an influence by the contact of the finger 5a of the passenger.

Since the detected temperature difference thereby becomes larger than the predetermined temperature “Tb”, the electronic control unit 30 determines YES at the step S230. The electronic control unit 30 controls the switch 31 at a step S221 in such a way that the connection between the plus-side electrode of the battery Ba and the heat generating unit 12 is cut off. In other words, the heat generating unit 12 is turned off via the switch 31.

The electric current flow from the battery Ba to the ground via the switch 31 and the heat generating unit 12 is terminated. The heat generation at the heat generating unit 12 is thereby terminated. The temperature of the heat generating unit 12 is finally decreased.

At a step S240, the electronic control unit 30 determines whether a condition that the detected temperature difference is larger than the predetermined temperature “Tb” continues for a period larger than a predetermined time “Tw”.

At the step S240, the electronic control unit 30 determines that a malfunction occurs in the heater apparatus 1 and determines YES, when the condition that the detected temperature difference is larger than the predetermined temperature “Tb” continues for the period longer than the predetermined time “Tw”. The process goes to a step S250 to stop the operation of the heater apparatus 1. In addition, the electronic control unit 30 memorizes in the memory device that the malfunction has occurred.

On the other hand, when the condition that the detected temperature difference is larger than the predetermined temperature “Tb” continues for the period shorter than the predetermined time “Tw”, the electronic control unit 30 determines that there is no malfunction in the heater apparatus 1 and determines NO at the step S240. Then, the process goes back to the step S230.

In a case that the finger 5a of the passenger is not in contact with any one of the two overlapping areas 14b of the outer surface 14a, each of the detected temperature of the two temperature sensors 15 does not receive any influence from the finger 5a of the passenger. Therefore, the detected temperature difference of the two temperature sensors 15 is smaller than the predetermined temperature “Tb”. The electronic control unit 30 determines NO at the step S230 and the process goes to the step S210.

In addition, there is a case in which the electronic control unit 30 determines based on the detection value of the detection unit 13 that the finger 5a of the passenger has been brought into contact with or come closer to the overlapping area 14c of the outer surface 14a overlapping the detection unit 13, and thereby the electronic control unit 30 determines YES at the step S210. Then, at the step S220, the switch 31 is so controlled that the connection between the plus-side electrode of the battery Ba and the heat generating unit 12 is cut off.

As above, the heat generating unit 12 is turned off via the switch 31. The temperature of the heat generating unit 12 is thereby decreased. The process goes back to the step S230.

The steps S210 and S220 correspond to the first control portion. The steps S101, S110, S121 and S130 correspond to the second control portion. The steps S230 and S221 correspond to the third control portion in the present embodiment.

In the present embodiment, the electronic control unit 30 determines whether or not the detected temperature difference of the two temperature sensors 15 is larger than the predetermined temperature “Tb” and thereby determines whether or not the finger 5a of the passenger has touched the overlapping area 14b of the outer surface 14a. Accordingly, it is possible to determine with high accuracy whether the finger 5a of the passenger has touched the overlapping area 14b (the second region) or not.

### Sixth Embodiment

In the above first to fifth embodiments, each of the heat generating unit 12, the electrodes 16a and 16b of the temperature sensor 15, the wirings 16c and 16d and the detection unit 13 is formed on the passenger side and/or the non-passenger side of the insulating substrate 11 in the Z-direction.

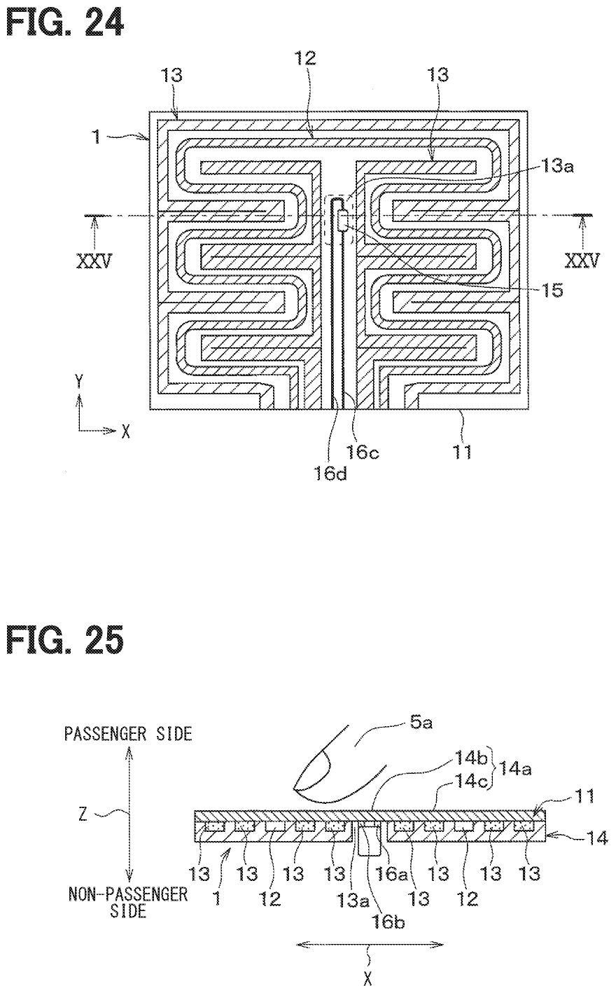

A sixth embodiment, in which all of the heat generating unit 12, the electrodes 16a and 16b of the temperature sensor 15, the wirings 16c and 16d and the detection unit 13 are formed on the non-passenger side of the insulating substrate 11 in the Z-direction, will be explained with reference to FIGS. 24 and 25. In FIGS. 24 and 25, the same reference numerals to those of FIGS. 2 and 3 designate the same part and the explanation thereof is omitted.

The present embodiment is mainly different from the first embodiment in the positions of the heat generating unit 12, the electrodes 16a and 16b of the temperature sensor 15, the wirings 16c and 16d and the detection unit 13.

In the present embodiment, each of the heat generating unit 12, the detection unit 13, the electrodes 16a and 16b of the temperature sensor 15 and the wirings 16c and 16d is formed in the same layer. The heat generating unit 12, the detection unit 13, the electrodes 16a and 16b of the temperature sensor 15 and the wirings 16c and 16d are arranged in such a way that they are offset from one another in the X-direction and in the Y-direction.

In the present embodiment, the insulating layer 14 is located on the non-passenger side of the insulating substrate 11 in the Z-direction. The insulating layer 14 is so formed that it covers the heat generating unit 12, the detection unit 13, the electrodes 16a and 16b of the temperature sensor 15 and the wirings 16c and 16d from the non-passenger side in the Z-direction.

In the present embodiment, the sensor hole 13a opened on the non-passenger side in the Z-direction is formed at a center portion of the insulating layer 14 in the X-direction and in the Y-direction. The sensor hole 13a is formed on the non-passenger side of the insulating substrate 11 in the Z-direction as a portion, for which the detection unit 13 is not formed. The temperature sensor 15 is arranged in the sensor hole 13a. In other words, the temperature sensor 15 is so arranged that it is offset from the heat generating unit 12 and the detection unit 13 in the X-direction and in the Y-direction.

In the present embodiment, the detection unit 13 is formed in such a way that it extends along the heat generating unit 12 in a meandering shape. The detection unit 13 forms a capacitor having an insulating body interposed between a pair of electrodes. In other words, the detection unit 13 forms the close-range sensor of the capacitance type, which detects the detection object (for example, the finger 5a of the passenger) by the change of electrostatic capacitance when the detection object comes closer to the detection unit 13.

In the present embodiment, the outer surface 14a is formed on not the passenger side of the insulating layer 14 in the Z-direction but the passenger side of the insulating substrate 11 in the Z-direction. In other words, the outer surface 14a is formed by the surface of the insulating substrate 11 on the passenger side in the Z-direction.

In addition, the temperature sensor 15, the detection unit 13 and the heat generating unit 12 are located on the non-passenger side of the insulating substrate 11 in the Z-direction (that is, on one of the sides in the thickness direction).

In the present embodiment having the above structure, the electronic control unit 30 carries out the contact detection process in the same manner to the first embodiment (FIG. 6).

When the finger 5a of the passenger is brought into contact with the overlapping area 14b of the outer surface 14a, which overlaps with the sensor hole 13a in the Z-direction, the detected temperature of the temperature sensor 15 rapidly decreases. The electronic control unit 30 determines YES at the step S200 (FIG. 6) and the process goes to the step S220 (FIG. 6), at which the heat generating unit 12 is turned off via the switch 31.

On the other hand, there is a case in which the electronic control unit 30 determines that the finger 5a of the passenger has touched or come close to the overlapping area 14c of the outer surface 14a overlapping the detection unit 13 in the Z-direction. And thereby the electronic control unit 30 determines YES at the step S210 (FIG. 6). In such a case, the electronic control unit 30 controls the switch 31 at the step S220 (FIG. 6) in such a way that the heat generating unit 12 is turned off via the switch 31.

As above, when the finger 5a of the passenger is brought into contact with the overlapping area 14b or the overlapping area 14c of the outer surface 14a, the electronic control unit 30 controls the switch 31 to turn off the heat generating unit 12.

In addition, the electronic control unit 30 of the present embodiment carries out the temperature control process in the same manner to the first embodiment, the explanation of which is omitted.

As above, in the present embodiment, the heat generating unit 12 is located on the non-passenger side of the outer surface 14a in the Z-direction. It is thereby possible to make smaller the distance between the heat generating unit 12 and the outer surface 14a. It is therefore possible to effectively transmit the heat from the heat generating unit 12 to the outer surface 14a. It is possible to ensure the amount of heat for the radiation heat emitted from the outer surface 14a. It is possible to obtain a sufficient heating performance.

In the present embodiment, the heat generating unit 12 and the temperature sensor 15 are located on the non-passenger side of the insulating substrate 11 in the Z-direction. Since the distance between the heat generating unit 12 and the temperature sensor 15 can be made smaller, it is possible to accurately detect the temperature of the heat generating unit 12. It is therefore possible to obtain the good temperature controllability for the heat generating unit 12.

In addition, since the temperature sensor 15 is located on the non-passenger side of the outer surface 14a in the Z-direction, it is avoided that the outer surface 14a becomes a concavo-convex shape by the temperature sensor 15. Therefore, the good appearance can be obtained, when viewed the outer surface 14a of the heater apparatus 1 from the passenger side in the Z-direction.

As above, since the temperature sensor 15 is provided at a proper position in the present embodiment, it is possible to provide the heater apparatus 1, which satisfies the requirements for the temperature controllability, the heating performance and the appearance, without adversely affecting the detection of the contact condition or proximity condition of the detection object.

In the present embodiment, each of the heat generating unit 12, the detection unit 13, the electrodes 16a and 16b of the temperature sensor 15 and the wirings 16c and 16d is formed in the same layer. It is thereby possible to make smaller a size of the heater apparatus 1 in the Z-direction.

### Further Embodiments and/or Modifications

(1) In the above first to fourth embodiments, the electric power supply to the heat generating unit 12 is cut off, when the finger 5a of the passenger has touched (or come closer to) the overlapping area 14c of the outer surface 14a, which overlaps with the detection unit 13 in the Z-direction. The present disclosure is not limited thereto but can be modified in the following manner.

Namely, the electronic control unit 30 may operate in the following manner, when the finger 5a of the passenger has touched or come closer to the overlapping area 14c. More exactly, the electronic control unit 30 may control the switch 31 in such a way that the electric current (a current supply amount) flowing from the battery Ba to the heat generating unit 12 is made smaller than that of a case, in which the electronic control unit 30 does not detect that the finger 5a of the passenger has touched or come closer to the overlapping area 14c.

(2) In the above first to fourth embodiments, the electric power supply to the heat generating unit 12 is cut off, when the finger 5a of the passenger has touched (or come closer to) the overlapping area 14b of the outer surface 14a, which overlaps with the temperature sensor 15 in the Z-direction. The present disclosure is not limited thereto but can be modified in the following manner.

Namely, the electronic control unit 30 may operate the switch 31 in the following manner, when the finger 5a of the passenger has touched or come closer to the overlapping area 14b. That is, the electronic control unit 30 may control the switch 31 in such a way that the electric current (a current supply amount) flowing from the battery Ba to the heat generating unit 12 is made smaller than that of the case, in which the electronic control unit 30 does not detect that the finger 5a of the passenger has touched or come closer to the overlapping area 14b.

(3) In the above fifth embodiment, the electronic control unit 30 controls the temperature of the heat generating unit 12, wherein one of the detected temperatures of the two temperature sensors 15, whichever is higher, is treated as the representing temperature. The fifth embodiment can be modified in the following manner, instead of the above structure and operation.

More than two temperature sensors 15 may be provided for one heat generating unit 12, wherein the electronic control unit 30 treats one of the detected temperatures of the more than two temperature sensors 15, whichever is the highest, as the representing temperature and controls the temperature of the heat generating unit 12.

In addition, the electronic control unit 30 may calculate the detected temperature difference between the highest temperature and the lowest temperature among the detected temperatures of the more than two temperature sensors 15 and may determine whether the detected temperature difference calculated above is larger than the predetermined temperature “Tb” or not.

The electronic control unit 30 determines whether or not the finger 5a of the passenger has touched the overlapping area 14b of the outer surface 14a, depending on the determination whether the detected temperature difference is larger than the predetermined temperature “Tb” or not.

(4) In the above first to fourth embodiments, the electronic control unit 30 controls the temperature of the heat generating unit 12 by turning on or turning off the switch 31 depending on the comparison between the detected temperature of the temperature sensor 15 and a threshold value (that is, the temperature “A” and the temperature “B”). The above embodiments can be modified in the following manner, instead of the above structure and operation.

Namely, the temperature of the heat generating unit 12 may be controlled by an switching operation of the switch 31 based on the comparison between the detected temperature of the temperature sensor 15 and the threshold value (that is, the temperature “A” and the temperature “B”).

More exactly, the electronic control unit 30 calculates a duty ratio, which shows a ratio between an ON-time “Ton” of the switch 31 and an OFF-time “Toff” of the switch 31, and controls the duty ratio based on the comparison between the detected temperature of the temperature sensor 15 and the threshold value (that is, the temperature “A” and the temperature “B”). In other words, an average current flowing to the heat generating unit 12 is controlled and an amount of heat generation at the heat generating unit 12 is controlled. The duty ratio is defined as “Ton/(Ton+Toff)”.

(5) In the above sixth embodiment, the detection unit 13 forms the close-range sensor of the capacitance type, which detects the detection object by the change of the electrostatic capacitance when the detection object comes closer to the detection unit 13. However, the sixth embodiment can be modified in such a way that the detection unit 13 may detect the contact or non-contact condition of the detection object based on an ON-OFF operation of a switch in the same manner to the fourth embodiment.

(6) In the above sixth embodiment, the outer surface 14a is formed by the passenger side surface of the insulating substrate 11 in the Z-direction. However, instead of the above structure, the sixth embodiment may be modified in such a way that an insulating layer is formed on the passenger side of the insulating substrate 11 and the outer surface 14a is formed by the insulating layer.

(7) The present disclosure is not limited to the above explained embodiments but can be further modified in various manners. Each of the above embodiments is not an unrelated embodiment to one another. It is possible to appropriately combine one of them to the other of them, except for such a combination that is clearly impossible. In each of the above embodiments, each part forming the embodiment is not always necessary, except for such a part which is explicitly explained as being a necessary one or except for such a part which is in principle considered as being a necessary one. In each of the above embodiments, in a case that the embodiment refers to a number, a figure, an amount, a range and so on for a component element, the present disclosure is not limited to such a specified number and so on, except for a case in which such a number is necessary or except for a case in which the embodiment is in principle limited to such a specified number or the like. In addition, in a case in which a shape, a positional relationship or the like of the component element is referred to in each of the above embodiments, the present disclosure is not limited to such a specified shape or such a positional relationship, except for the case in which it is explicitly referred to as being a necessary feature or except for the case in which the embodiment should be in principle limited to the shape or the positional relationship.

### SUMMARY

According to a first feature, which is explained in the above first to fifth embodiments or in one or all of the above further embodiments and/or modifications, the heater apparatus includes the heat generating unit for generating the heat upon receiving the electric power, the outer surface for radiating the heat from the heat generating unit and the detection unit for detecting that the object has been brought into contact with or has touched the outer surface.

The heater apparatus includes the first control portion for determining whether or not the object has touched the first region of the outer surface, which overlaps with the detection unit in the first direction, based on the detection of the detection unit, wherein the direction connecting the heat generating unit to the outer surface is defined as the first direction. When the first control portion detects that the object has touched the first region, the first control portion terminates the electric power supply to the heat generating unit or makes the amount of the electric power supply to the heat generating unit smaller than that of the case, in which the first control portion does not detect that the object has touched the first region.

The temperature sensor is arranged at the position, which is offset from the detection unit in the second direction, wherein the direction perpendicular to the first direction is defined as the second direction. The heater apparatus includes the temperature sensor for detecting the temperature of the heat generating unit and the second control portion for controlling the temperature of the heat generating unit based on the detected temperature of the temperature sensor.

The heater apparatus includes the third control portion for determining based on the detected temperature of the temperature sensor whether or not the object has touched the second region of the outer surface, which overlaps with the temperature sensor in the first direction. When the third control portion determines that the object has touched the second region, the third control portion makes the amount of the electric power supply to the heat generating unit smaller than that of the case, in which the third control portion determines that the object has not touched the second region, or the third control portion terminates the electric power supply to the heat generating unit.

According to a second feature of the present disclosure, the detection unit is located on the side of the heat generating unit opposite to the outer surface.

According to a third feature of the present disclosure, the temperature sensor is arranged in such a way that it overlaps with the heat generating unit in the first direction. According to the above structure, the temperature sensor can accurately detect the temperature of the heat generating unit.

According to a fourth feature of the present disclosure, the temperature sensor is exposed to the outside on the side opposite to the outer surface. Since the heat capacity of the surrounding portion of the temperature sensor becomes smaller, it is possible to increase the sensitivity when the temperature sensor detects that the object touches the second region based on the detected temperature of the temperature sensor.

According to a fifth feature of the present disclosure, the heater apparatus includes the electronic control unit having the first control portion, the second control portion and the third control portion. The heater apparatus further includes the insulating substrate, which is made of the electrically insulating material, wherein the temperature sensor, the detection unit and the heat generating unit are mounted to the insulating substrate.

The heater apparatus includes the electrodes of the temperature sensor for transmitting the detection signal of the temperature sensor to the electronic control unit and the electrodes of the detection unit for transmitting the detection signal of the detection unit to the electronic control unit. The insulating substrate, the heat generating unit, the electrodes of the temperature sensor and the electrodes of the detection unit are formed as one integral product.

According to a sixth feature of the present disclosure, the detection unit is composed of the switch which is turned on when the object has touched the first region or which is turned off when the object is separated from the first region.

According to a seventh feature of the present disclosure, the heater apparatus includes the electronic control unit having the first control portion, the second control portion and the third control portion. The heater apparatus further includes the insulating substrate, which is made of the electrically insulating material, wherein the temperature sensor, the detection unit and the heat generating unit are mounted to the insulating substrate.

The heater apparatus includes the electrodes of the temperature sensor for transmitting the detection signal of the temperature sensor to the electronic control unit. The insulating substrate, the heat generating unit, the electrodes of the temperature sensor and the electrodes of the detection unit are formed as one integral product.

According to an eighth feature of the present disclosure, the detection unit detects that the object has touched the first region, based on the change of the electrostatic capacitance.

According to a ninth feature of the present disclosure, the heater apparatus includes the second temperature sensor, which is offset from the first temperature sensor and the detection unit in the second direction and which detects the temperature of the heat generating unit, wherein the temperature sensor is defined as the first temperature sensor and wherein the second temperature sensor may include multiple temperature sensors. The third control portion determines whether the detected temperature difference between the first and the second temperature sensors is larger than the threshold value or not, and thereby it determines whether the object has touched the second region or not. Accordingly, it is possible to determine with high accuracy whether the object has touched the second region or not.

According to a tenth feature of the present disclosure, the insulating substrate is located between the temperature sensor as well as the detection unit and the heat generating unit.

According to an eleventh feature of the present disclosure, the insulating substrate is formed in the thin film form and the temperature sensor, the detection unit and the heat generating unit are located on one of the sides of the insulating substrate in the thickness direction.

What is claimed is:

1. A heater apparatus comprising:
a heat generating unit for generating heat upon receiving electric power supply;
an outer surface for radiating the heat of the heat generating unit;
a detection unit for detecting whether or not an object has been brought into contact with the outer surface;
a first control portion for determining based on detection of the detection unit whether or not the object has been brought into contact with a first region of the outer surface, which overlaps with the detection unit in a first direction,
wherein a direction for connecting the heat generating unit to the outer surface is defined as the first direction, and
wherein, when the first control portion determines that the object has been brought into contact with the first region, the first control portion terminates the electric power supply to the heat generating unit or makes an amount of the electric power supply to the heat generating unit smaller than that of a case in which the first control portion does not determine that the object has been brought into contact with the first region;
a temperature sensor, which is arranged at a position being offset from the detection unit in a second direction and which detects temperature of the heat generating unit, wherein a direction perpendicular to the first direction is defined as a second direction;
a second control portion for controlling the temperature of the heat generating unit based on a detected temperature of the temperature sensor; and
a third control portion for determining based on the detected temperature of the temperature sensor whether or not the object has been brought into contact with a second region of the outer surface, which overlaps with the temperature sensor in the first direction,
wherein, when the third control portion determines that the object has been brought into contact with the second region, the third control portion makes the amount of the electric power supply to the heat generating unit smaller than that of a case in which the third control portion determines that the object is not brought into contact with the second region, or the third control portion terminates the electric power supply to the heat generating unit.

2. The heater apparatus according to claim 1, wherein
the detection unit is located on a side of the heat generating unit opposite to the outer surface.

3. The heater apparatus according to claim 1, wherein
the temperature sensor is located in such a way that it overlaps with the heat generating unit in the first direction.

4. The heater apparatus according to claim 1, wherein
the temperature sensor is exposed to an outside of the heater apparatus in the first direction opposite to the outer surface.

5. The heater apparatus according to claim 1, further comprising:
an electronic control unit having the first control portion, the second control portion and the third control portion;
an insulating substrate made of electrical insulating material, to which the temperature sensor, the detection unit and the heat generating unit are mounted;
sensor electrodes for transmitting a detection signal of the temperature sensor to the electronic control unit; and
detection electrodes for transmitting a detection signal of the detection unit to the electronic control unit,
wherein the insulating substrate, the heat generating unit, the sensor electrodes and the detection electrodes are formed as one integral product.

6. The heater apparatus according to claim 1, wherein
the detection unit forms a switch, which is turned on when the object is brought into contact with the first region and which is turned off when the object is separated from the first region.

7. The heater apparatus according to claim 1, further comprising:
an electronic control unit having the first control portion, the second control portion and the third control portion;
an insulating substrate made of electrical insulating material, to which the temperature sensor, the detection unit and the heat generating unit are mounted; and
sensor electrodes for transmitting a detection signal of the temperature sensor to the electronic control unit,
wherein the insulating substrate, the heat generating unit, the sensor electrodes and the detection unit are formed as one integral product.

8. The heater apparatus according to claim 1, wherein
the detection unit detects that the object has been brought into contact with the first region by a change of electrostatic capacitance.

9. The heater apparatus according to claim 1, wherein
the temperature sensor corresponds to a first temperature sensor,
the heater apparatus further comprises one second temperature sensor or more than one second temperature sensors, which is or are offset in the second direction from the first temperature sensor and the detection unit,
the third control portion determines whether or not the object has been brought into contact with the second region, by determining whether or not a temperature difference between a detected temperature of the first temperature sensor and a detected temperature of the second temperature sensor is larger than a threshold temperature.

10. The heater apparatus according to claim 7, wherein
the insulating substrate is located between the temperature sensor and the heat generating unit and between the detection unit and the heat generating unit.

11. The heater apparatus according to claim 7, wherein
the insulating substrate is formed in a thin film form, and
the temperature sensor, the detection unit and the heat generating unit are formed on only one of the sides of the insulating substrate in its thickness direction.
